(19) United States
(12) Patent Application Publication
(10) Pub. No.: US 2025/0128366 A1
(43) Pub. Date: Apr. 24, 2025

(54) SEAT PULLER SYSTEM, RECIPROCATING PUMP VALVE SEAT PULLER ASSEMBLY, PROCESS, AND METHOD OF USE

(71) Applicant: Steven K. Deel, Overland Park, KS (US)

(72) Inventor: Steven K. Deel, Overland Park, KS (US)

(21) Appl. No.: 18/894,067

(22) Filed: Sep. 24, 2024

Related U.S. Application Data
(60) Provisional application No. 63/544,649, filed on Oct. 18, 2023.

(51) Int. Cl. B23P 15/00; E21B 43/12; F04B 53/10

(52) U.S. Cl. CPC B23P 15/001; E21B 43/121; F04B 53/10

(57) ABSTRACT

A seat puller system, a reciprocating pump valve seat puller assembly, process, and method of use are presented. The disclosed valve seat puller is configured and designed to provide pump owners and service companies with a cost-effective solution that is more robust and has an increased lifespan when compared to those in the art. The increased strength of the disclosure reduces potential safety risks associated with the use of the tool, also disclosed. The seat puller is limited in components, further enhancing cost effectiveness for installation and maintenance.

### CROSS-REFERENCE TO RELATED APPLICATIONS

The present application claims priority to the U.S. Provisional Patent Application No. 63/544,649 which was filed on Oct. 18, 2023, which is hereby incorporated by reference herein in its entirety, including any figures, tables, or drawings.

### FIELD OF THE INVENTION

This disclosure relates to a seat puller system, a reciprocating pump valve seat puller assembly, process, and method of use. More specifically, and without limitation, the present disclosure relates to a valve seat puller designed and configured to provide reciprocating pump owners and service companies with a cost-effective solution with improved life-span, maintenance costs, and safety features.

### BACKGROUND OF THE INVENTION

The drilling and production of oil and gas wells is well known in the art. Many advances and technological advancements have been made in this field due to the nature and need of energy throughout the world.

Drilling and production of oil and gas wells often involves the use of large, heavy duty reciprocating pumps. Pressurized pumping systems are well known in the art. Pressurized pumps are the predominant fuel-pumping method used in the art today. As one example, and used herein for ease of explanation and application, reciprocating pumps are utilized in the drilling process to deliver high pressure fluid for fuel extraction. These pumps, also referred to as mud pumps, may be single or multi-cylinder pumps and/or may also refer to as multiplex pumps, such as those found in fracking applications. Said another way, the drilling or oil and gas wells used in drilling involve and require the use of large reciprocating pumps generally referred to as mud pumps. These pumps provide high pressure drilling fluid also known as drilling mud, to the well bore.

High pressure pumps, or mud pumps, are typically composed of two sections and/or two ends, a power end and a fluid end. The fluid end of a mud pump houses valves which separate high and low pressure areas within the fluid end. The fluid end block also have several openings through which a number of valves are installed and/or removed for maintenance. In order to seal these openings, valve covers, which are durable to the high pressure operations are installed on the fluid end, to contain the high pressure fluid. Traditional valve cover designs for mud pumps consist of the following components: Seal, Seal Retainer (plug), Threaded ring, and a screw gland.

Valve assemblies installed within the fluid end of the reciprocating pump are vital to the reciprocating pump's ability to generate the required high pressure fluid needed in the production of oil and gas. A typical valve assembly consists of a valve, a spring, and a valve seat. These components are considered expendable components. As a result, valve assemblies of the current state of the art must be replaced frequently as part of the normal maintenance process of any pump.

A typical valve seat is manufactured from high strength steel and has a tapered outside diameter. When installed, a typical valve seat forms a tight, metal-to-metal type, seal within the tapered bore of the fluid end of the reciprocating pump. In a typical valve seat, the valve and spring can be removed relatively easily by hand. However, the valve seat must be removed with the use of specialized tooling, and tremendous force, due to its press fit within the fluid end; the press fit designed to withstand large forces using large forces. This specialized tooling, found in the existing state of the art, consists of a high-pressure hydraulic jack and a valve seat puller. In a typical application, axial forces in excess of 100 tons are applied to the valve seat puller to remove the valve seat.

These high forces, required in the existing state of the art for valve seat removal, often result in the failure of the valve seat puller. This common, and expected occurrence, results in additional costs. In addition, the failure of the valve seat puller causes a safety risk, due to the potential for components being ejected in the work area, when and if, a failure occurs.

Thus, there is a long-felt need in the art for a seat puller system, a reciprocating pump valve seat puller assembly, process, and method of use which improves upon the state of the art which provides an improved longevity, lower operating costs, improved maintenance costs, improved safety, and no specialized tooling; for ease of maintenance, replacement, and the like.

The disclosure herein provides these advantages and others as will become clear from the specification and claims provided.

### SUMMARY OF THE INVENTION

A seat puller system, a reciprocating pump valve seat puller assembly, process, and method of use are presented.

More specifically, and without limitation, the present disclosure relates to a seat puller system, a reciprocating pump valve seat puller assembly, process, and method of use which improves upon the state of the art which provides an improved longevity, lower operating costs, improved maintenance costs, improved safety, and no specialized tooling; for ease of maintenance, replacement, and the like.

Thus, it is a primary object of the disclosure to provide a seat puller system, a reciprocating pump valve seat puller assembly, process, and method of use that improves upon the state of the art.

Another object of the disclosure is to provide a seat puller system, a reciprocating pump valve seat puller assembly, process, and method of use that provides a design in compression rather than in tension; existing seat pullers have jaws that are in tension which results in high stresses and eventual failure. The present disclosure provides a design in compression.

Yet another object of the disclosure is to provide a seat puller system, a reciprocating pump valve seat puller assembly, process, and method of use that provides a unique expander component; the expander component provided prevents the jaw from deflecting towards the stem; jaw deflection towards stem is a common issue plaguing the state of the art.

Another benefit of the present disclosure is that the present disclosure has less than half of the components of the current designs in the state of the art. This reduction in components provides for myriad of benefits such as, but not limited to, lower manufacturing cost, easier maintenance, lower maintenance costs, improved durability.

Another object of the disclosure is to provide a seat puller system, a reciprocating pump valve seat puller assembly, process, and method of use that provides a cost effective solution for maintaining seat pullers.

Yet another object of the disclosure is to provide a seat puller system, a reciprocating pump valve seat puller assembly, process, and method of use that provides a more robust, longer lasting valve seat puller.

Another object of the disclosure is to provide a seat puller system, a reciprocating pump valve seat puller assembly, process, and method of use that provides a valve seat puller with an increased lifespan, relative to existing seat pullers.

Yet another object of the disclosure is to provide a seat puller system, a reciprocating pump valve seat puller assembly, process, and method of use that reduces safety risks associated with installation and maintenance of seat pullers.

Another object of the disclosure is to provide a seat puller system, a reciprocating pump valve seat puller assembly, process, and method of use that utilizes a high strength steel rod.

Yet another object of the disclosure is to provide a seat puller system, a reciprocating pump valve seat puller assembly, process, and method of use that utilizes a through hole so that a pin can engage the device, preventing the stem from turning when rotating the expander.

Another object of the disclosure is to provide a seat puller system, a reciprocating pump valve seat puller assembly, process, and method of use that includes an expander which expands the jaws to lock the jaws around the valve seat during removal.

Yet another object of the disclosure is to provide a seat puller system, a reciprocating pump valve seat puller assembly, process, and method of use that has a tapered expander, which improves engagement of the machined bevel located on the upper end of the jaw assembly.

Another object of the disclosure is to provide a seat puller system, a reciprocating pump valve seat puller assembly, process, and method of use that provides a threaded inside diameter of the expander.

Yet another object of the disclosure is to provide a seat puller system, a reciprocating pump valve seat puller assembly, process, and method of use that provides clockwise rotation for engagement and counterclockwise rotation for disengagement or upward travel.

Another object of the disclosure is to provide a seat puller system, a reciprocating pump valve seat puller assembly, process, and method of use that includes a flange component designed to limit the travel of the expander through the jaw assembly.

Yet another object of the disclosure is to provide a seat puller system, a reciprocating pump valve seat puller assembly, process, and method of use that includes a plurality of jaw segments forming an arc.

Another object of the disclosure is to provide a seat puller system, a reciprocating pump valve seat puller assembly, process, and method of use that includes a plurality of o-rings.

Yet another object of the disclosure is to provide a seat puller system, a reciprocating pump valve seat puller assembly, process, and method of use that includes an elastomeric band.

Another object of the disclosure is to provide a seat puller system, a reciprocating pump valve seat puller assembly, process, and method of use that includes a unique o-ring design which causes the elastomeric bands installed around the center of the jaws which keeps the jaw assembly in a retracted position when not energized by the expander.

Yet another object of the disclosure is to provide a seat puller system, a reciprocating pump valve seat puller assembly, process, and method of use that includes a lower retaining nut.

Another object of the disclosure is to provide a seat puller system, a reciprocating pump valve seat puller assembly, process, and method of use that includes an expander feature which prevents the jaw from deflecting towards the stem.

Yet another object of the disclosure is to provide a seat puller system, a reciprocating pump valve seat puller assembly, process, and method of use that includes a lower retainer nut which supports the bottom shoulder of the jaw; which causes the bottom shoulder to cause compressive forces.

Another object of the disclosure is to provide a seat puller system, a reciprocating pump valve seat puller assembly, process, and method of use that is easy to use.

Yet another object of the disclosure is to provide a seat puller system, a reciprocating pump valve seat puller assembly, process, and method of use that is safe to use.

Another object of the disclosure is to provide a seat puller system, a reciprocating pump valve seat puller assembly, process, and method of use that has less than 50% of the components of existing seat puller assemblies.

Yet another object of the disclosure is to provide a seat puller system, a reciprocating pump valve seat puller assembly, process, and method of use that is quick and efficient.

Yet another object of the disclosure is to provide a seat puller system, a reciprocating pump valve seat puller assembly, process, and method of use that is robust.

Another object of the disclosure is to provide a seat puller system, a reciprocating pump valve seat puller assembly, process, and method of use that saves time for a user.

Another object of the disclosure is to provide a seat puller system, a reciprocating pump valve seat puller assembly, process, and method of use that are high quality.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a top, perspective view of a reciprocating pump; the view showing the pump having a power end and a fluid end.

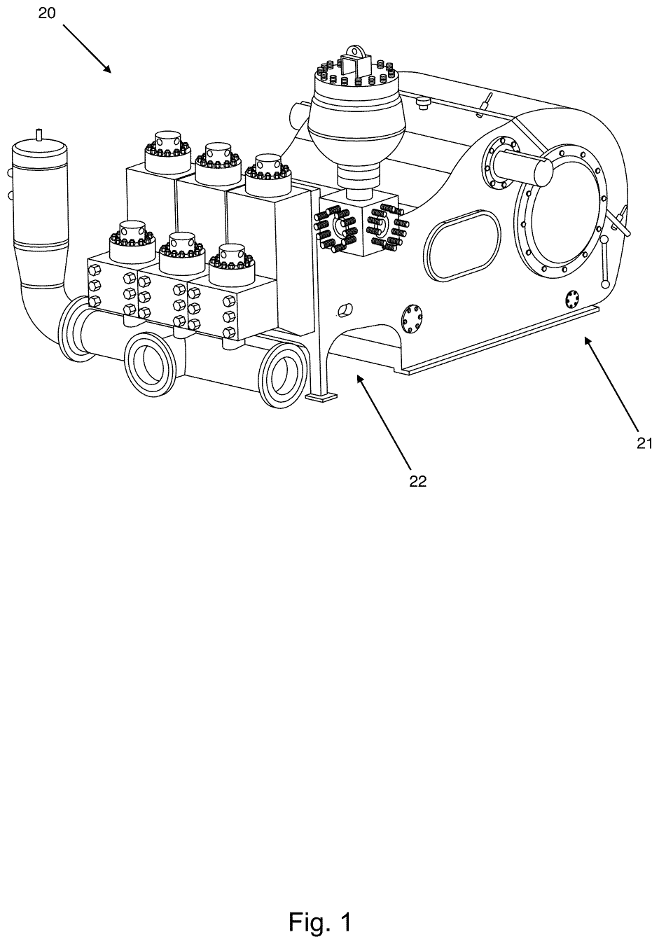

FIG. 2 is a top, perspective view of a fluid end of a reciprocating pump.

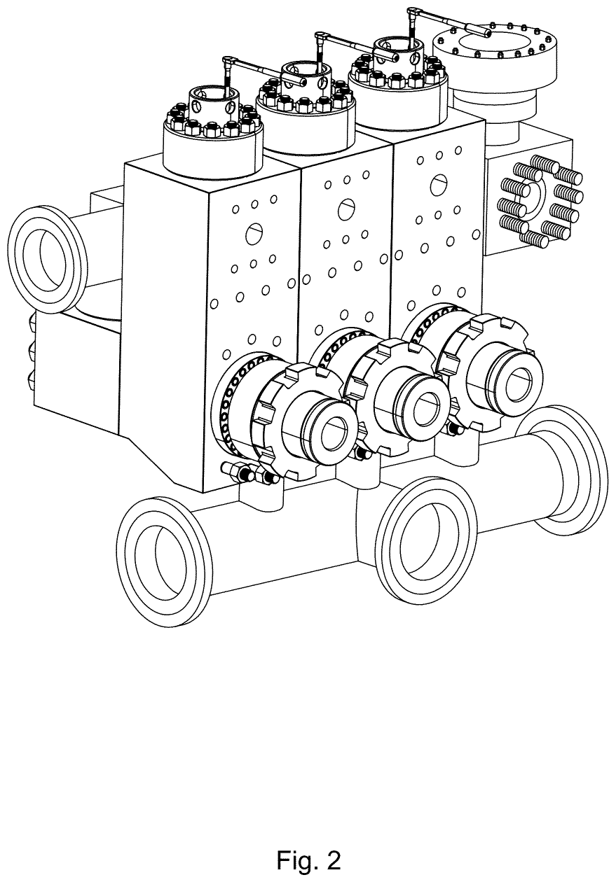

FIG. 3 is a top, perspective view of a fluid end of a reciprocating pump.

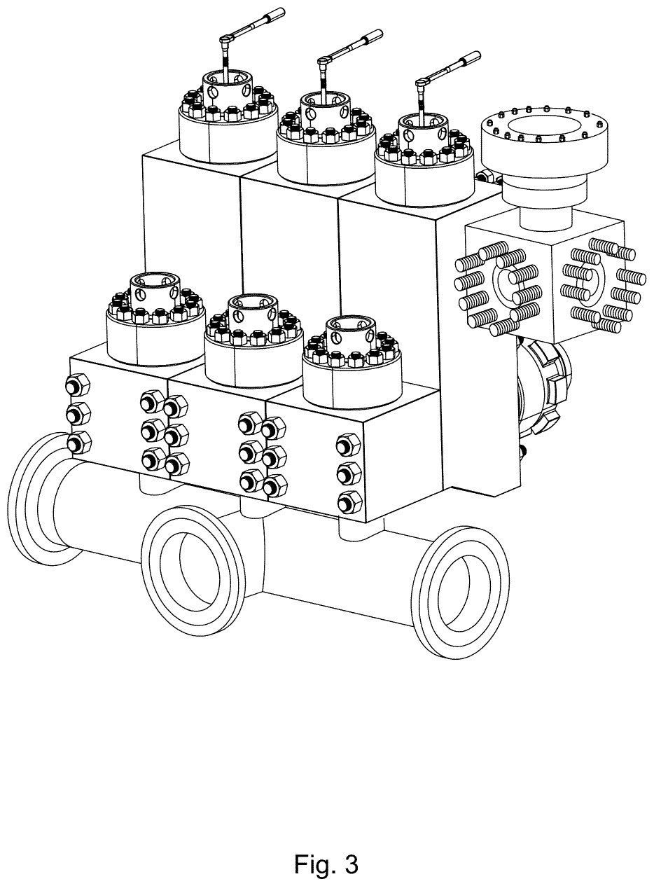

FIG. 4 is a top, perspective view of a valve cover; the view showing an engaged seat puller; the view showing a valve cover having a valve, a valve seat, and a plurality of hex nuts.

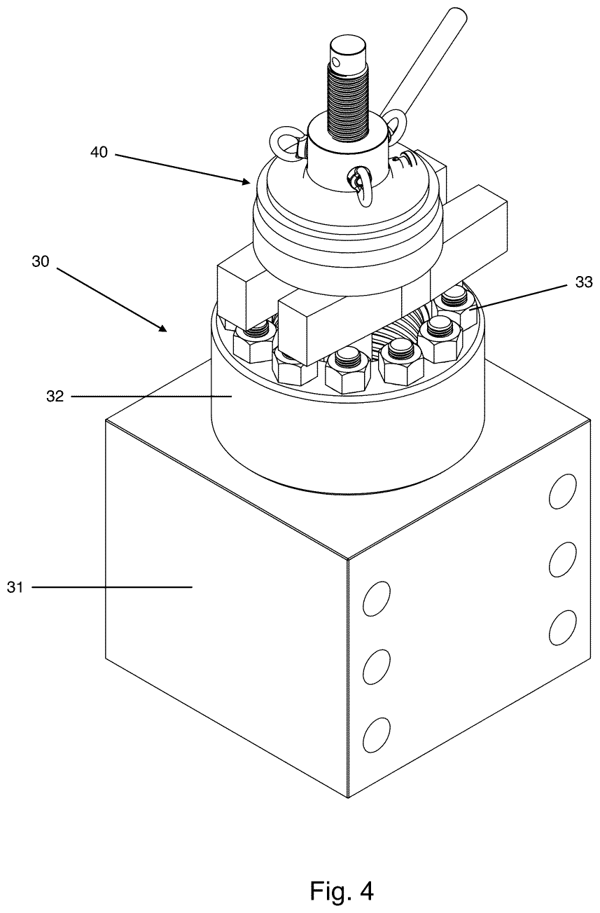

FIG. 5 is a cross sectional view of the fluid end of a reciprocating pump.

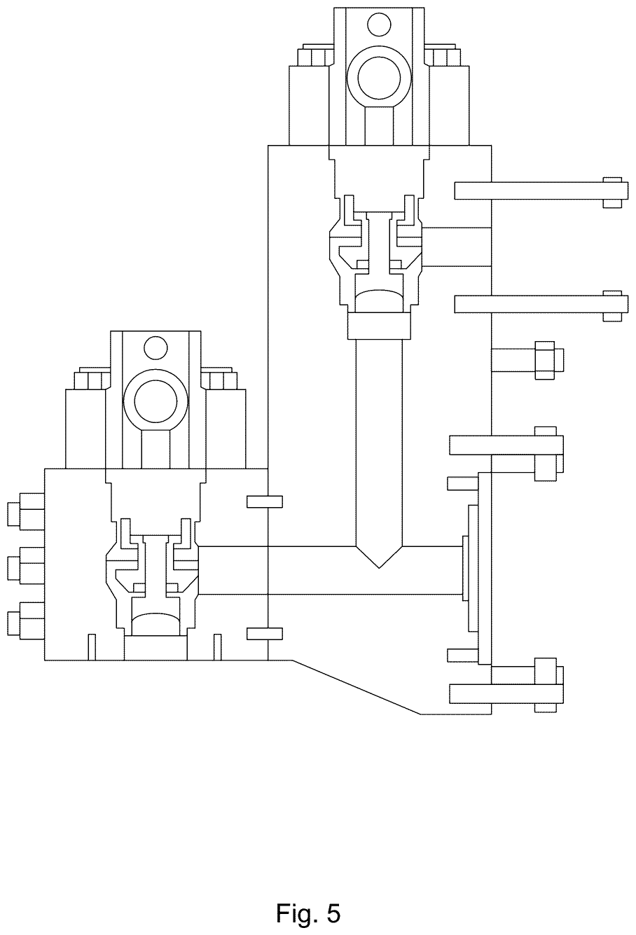

FIG. 6 is a cross sectional view of a valve cover.

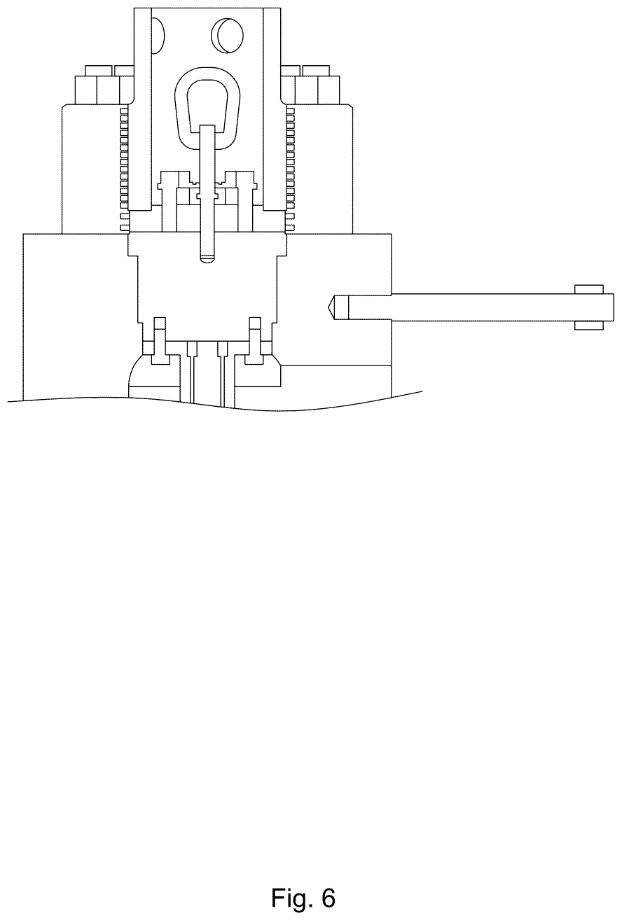

FIG. 7 is a top, perspective view of a valve cover.

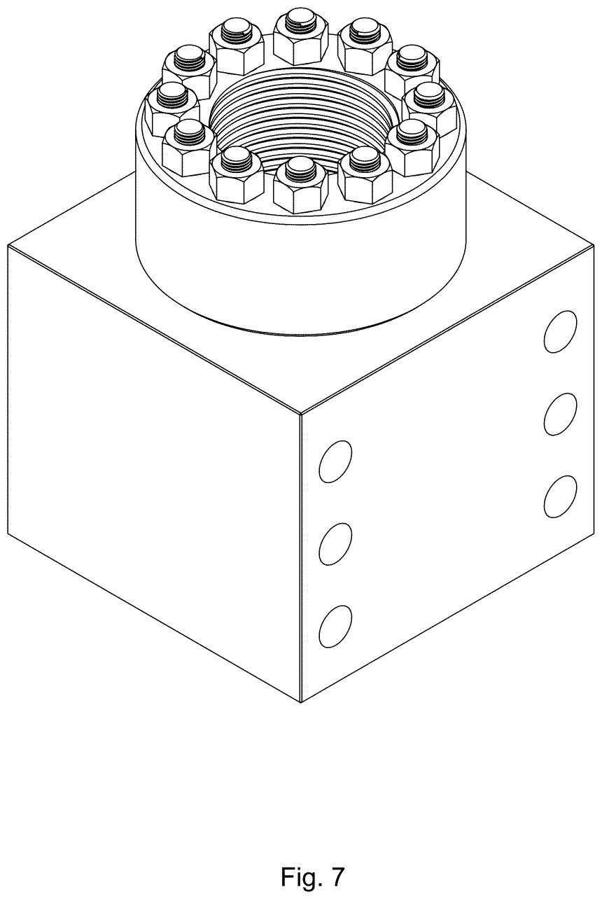

FIG. 8 is a top, perspective view of a valve seat.

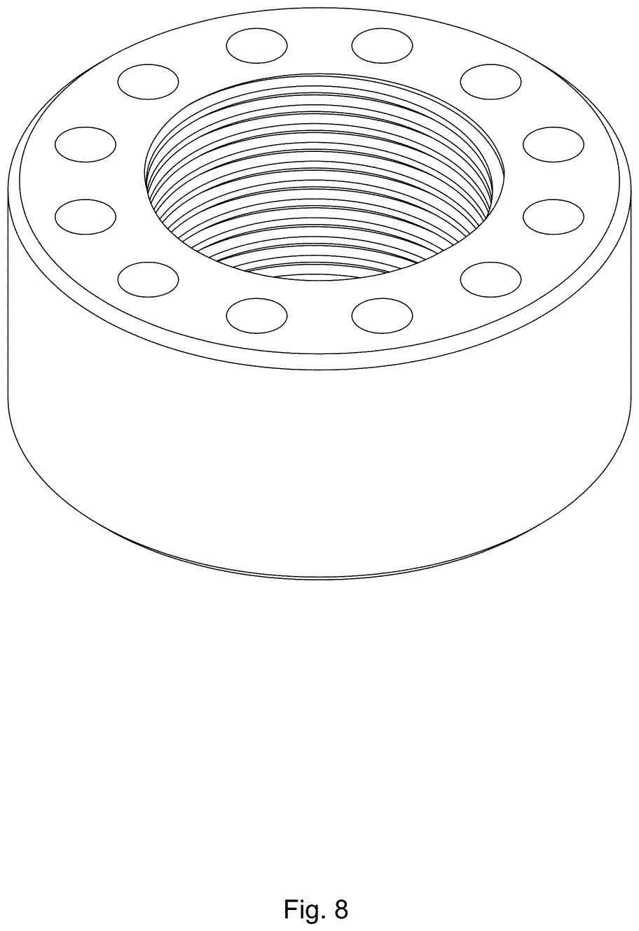

FIG. 9 is a top, perspective view of a valve cover.

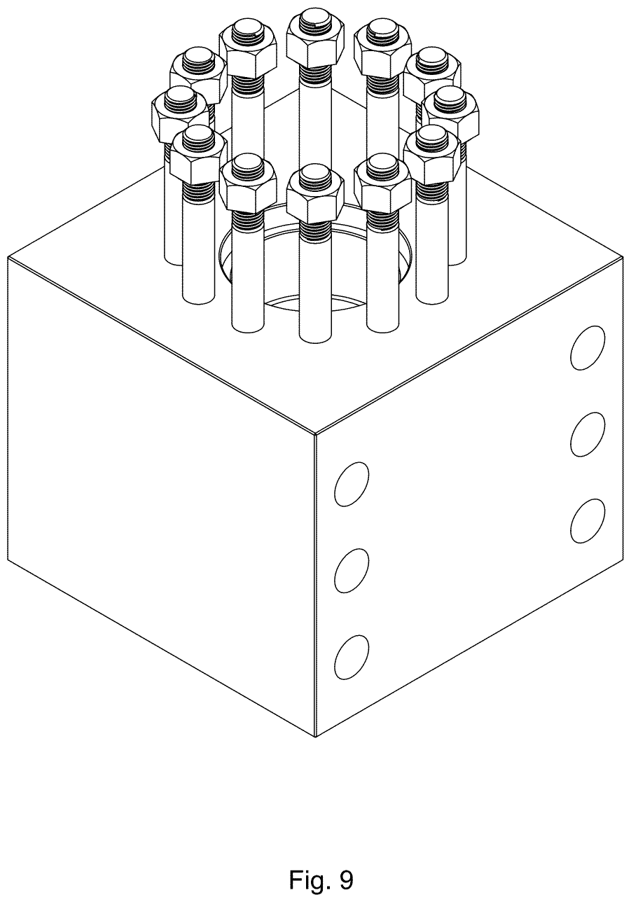

FIG. 10 is a top, perspective view of a valve seat.

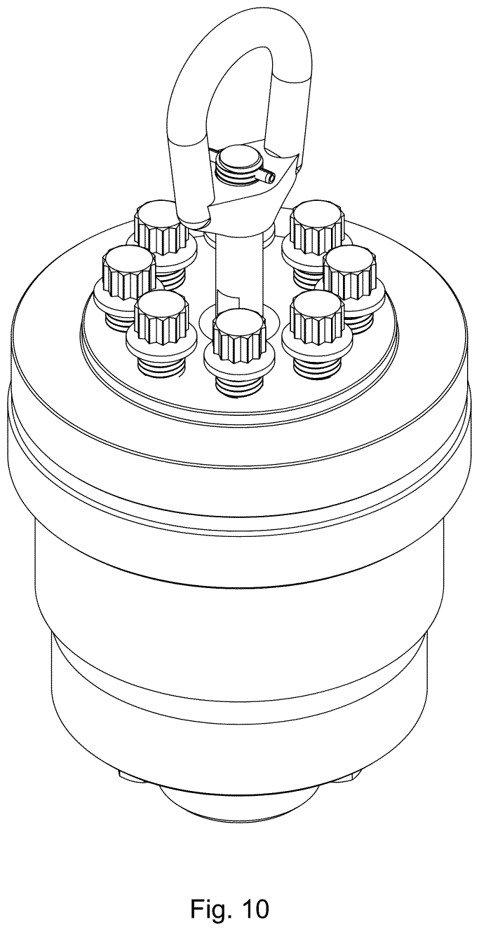

FIG. 11 is a front view of a seat puller assembly and an expanding rotator tool.

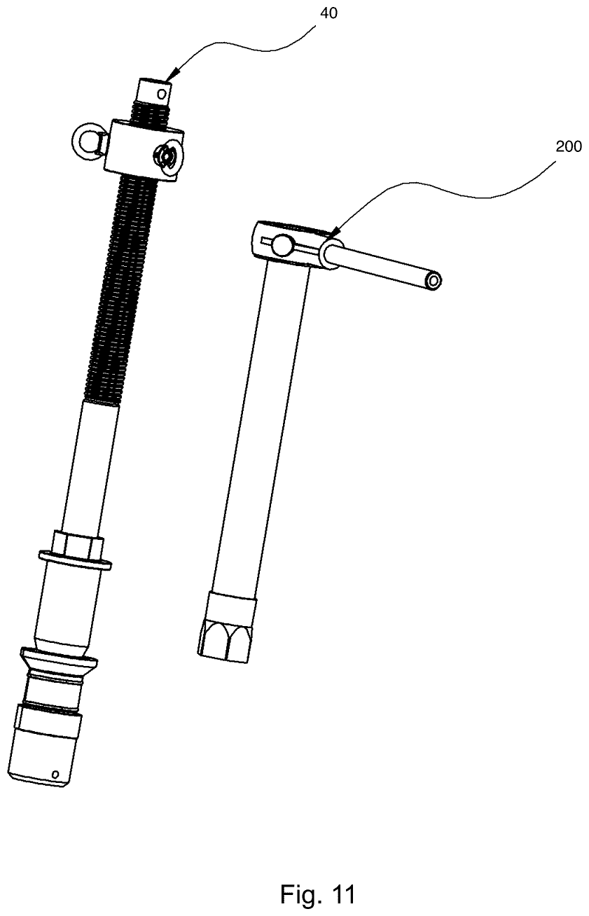

FIG. 12 is a top, perspective view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

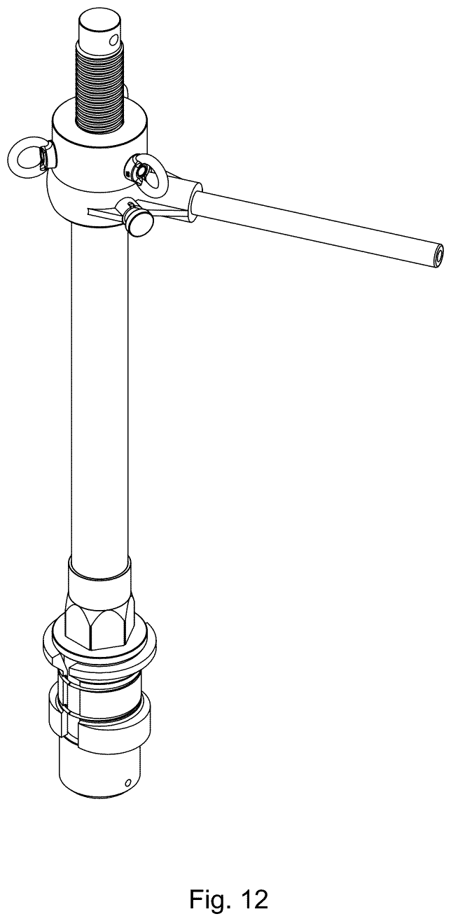

FIG. 13 is a bottom, perspective view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

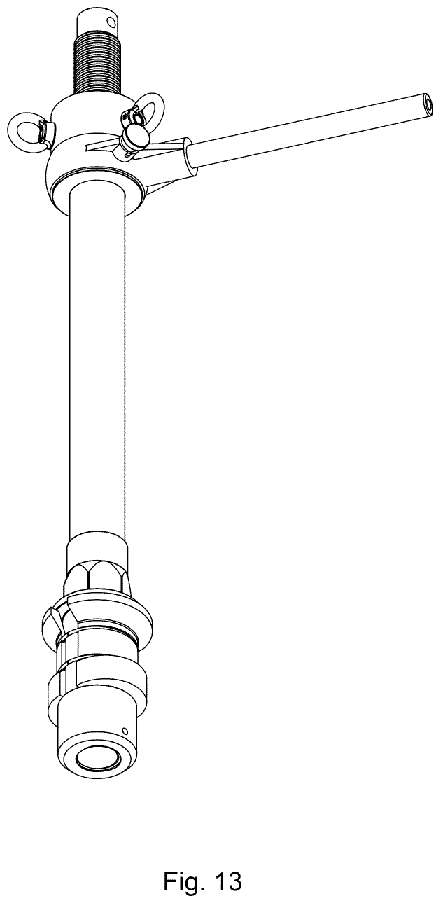

FIG. 14 is a front view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

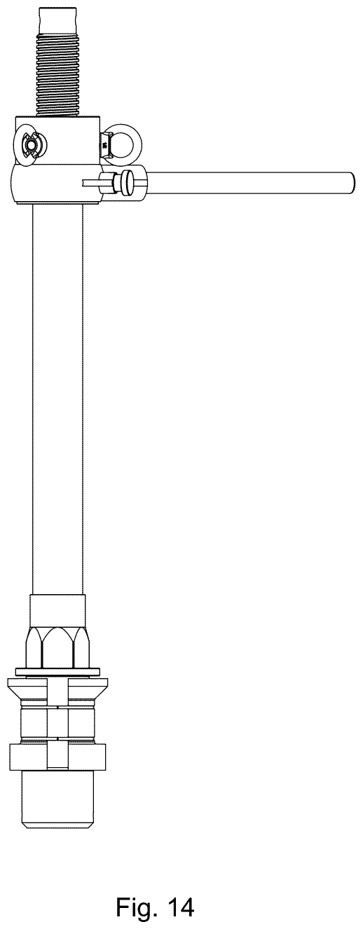

FIG. 15 is a rear view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

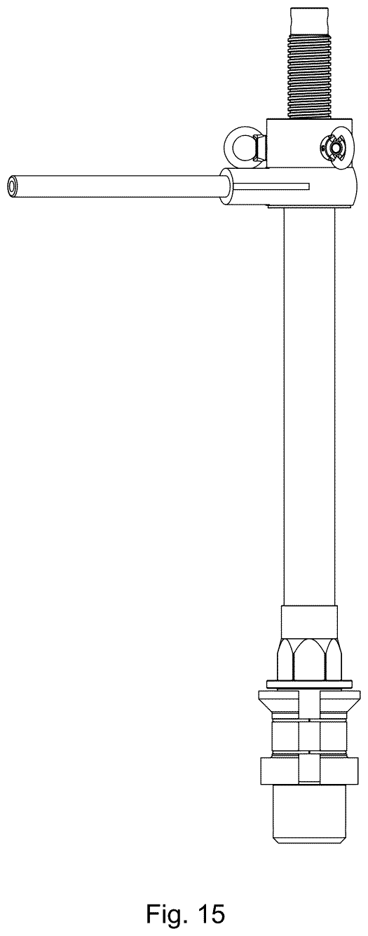

FIG. 16 is a top view of a seat puller assembly and expanding rotator tool; the view showing the expanding rotator tool engaged with the seat puller assembly; the view showing the seat puller assembly having a stem.

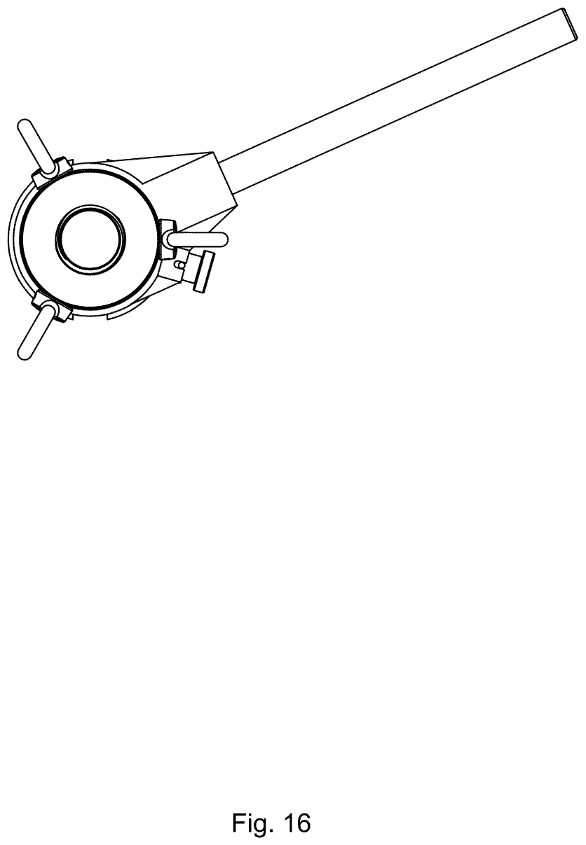

FIG. 17 is a top view of a seat puller assembly and expanding rotator tool; the view showing the expanding rotator tool engaged with the seat puller assembly; the view showing the seat puller assembly having a stem; the view showing the seat puller assembly having a lower retaining nut.

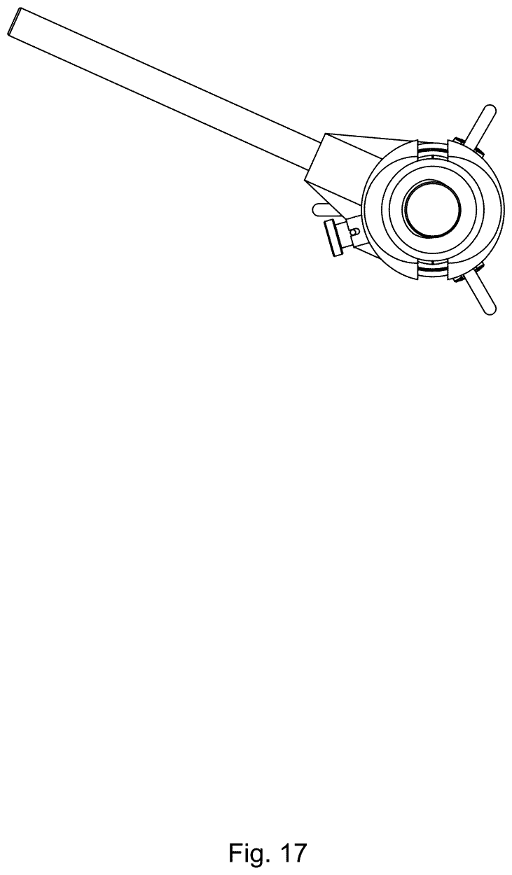

FIG. 18 is a side view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

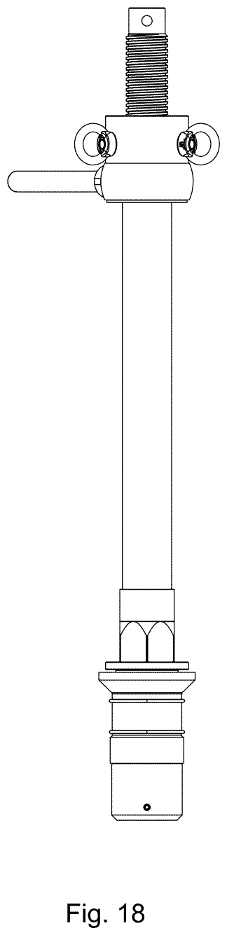

FIG. 19 is a side view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

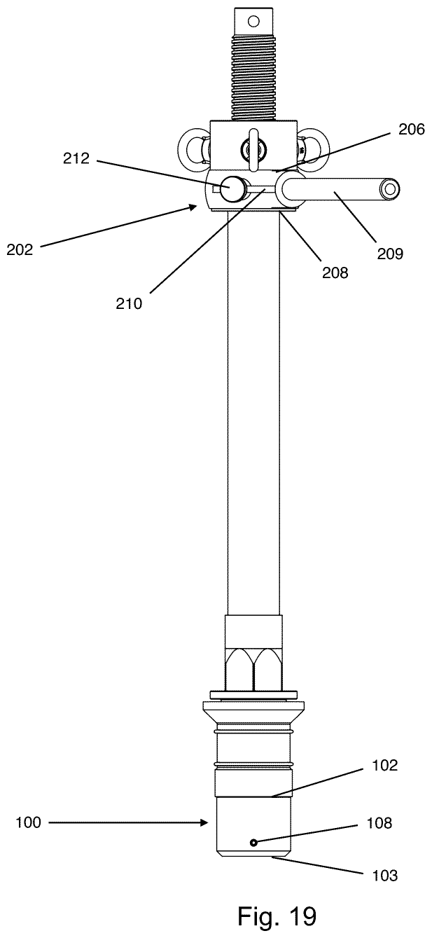

FIG. 20 is a top, perspective view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

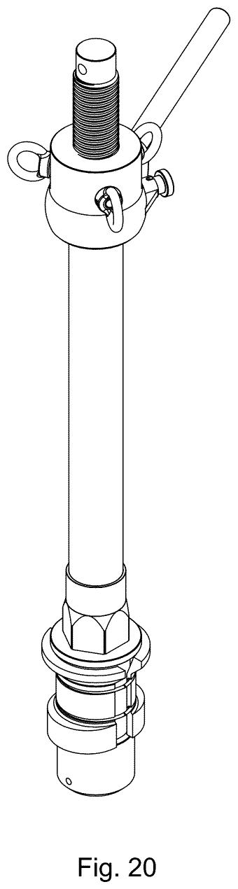

FIG. 21 is an isometric, exploded view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

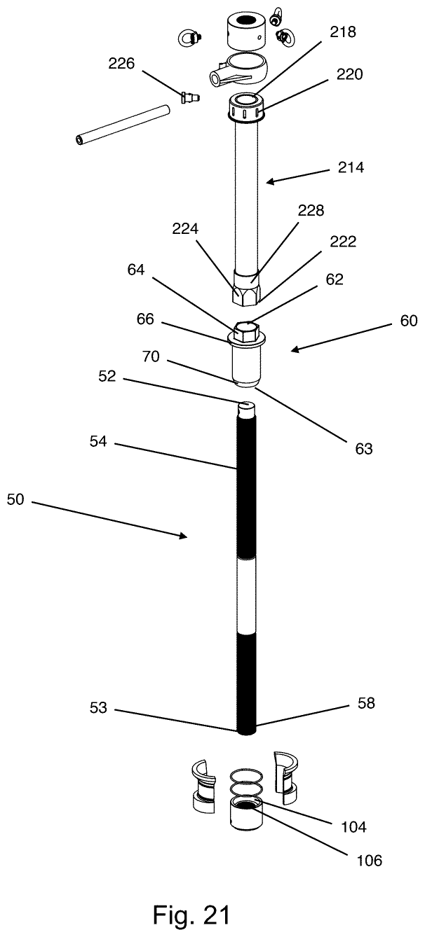

FIG. 22 is a lower isometric, exploded view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

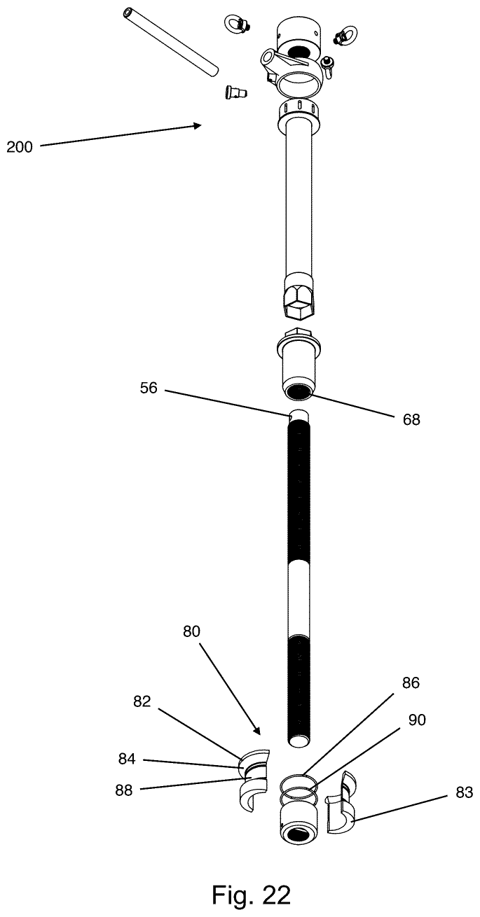

FIG. 23 is a top isometric, exploded view of a seat puller assembly and expanding rotator tool; the view showing the expanding rotator tool engaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

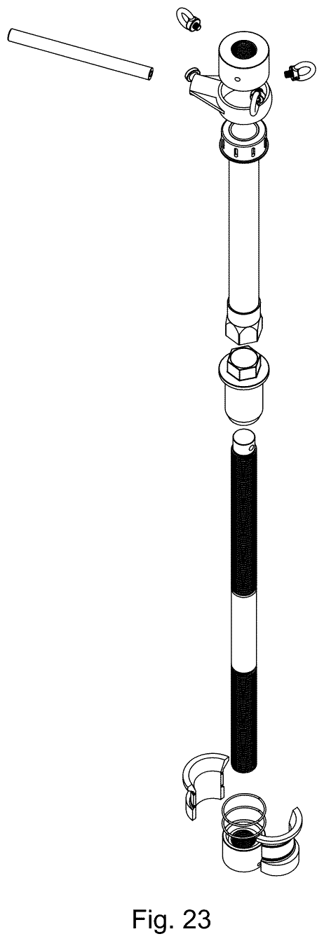

FIG. 24 is a cross sectional view of the fluid end of a reciprocating pump.

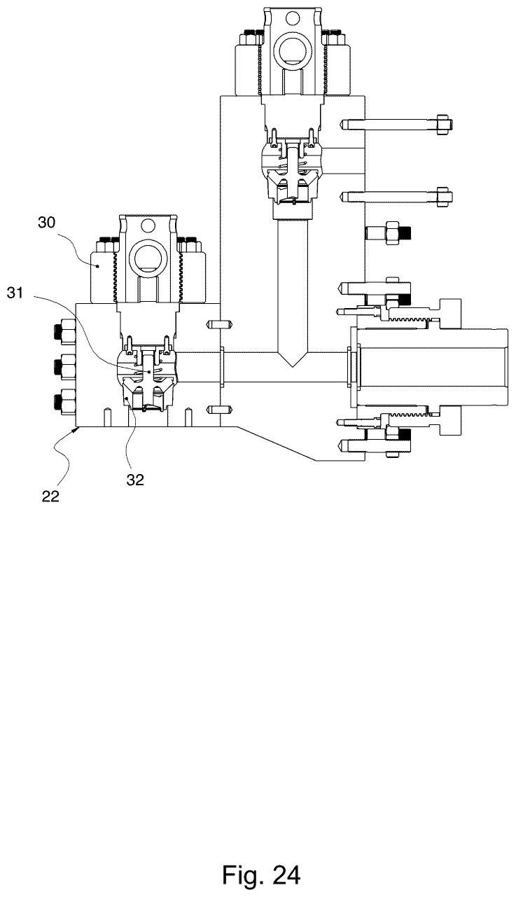

FIG. 25 is a cross sectional view of the fluid end of a reciprocating pump.

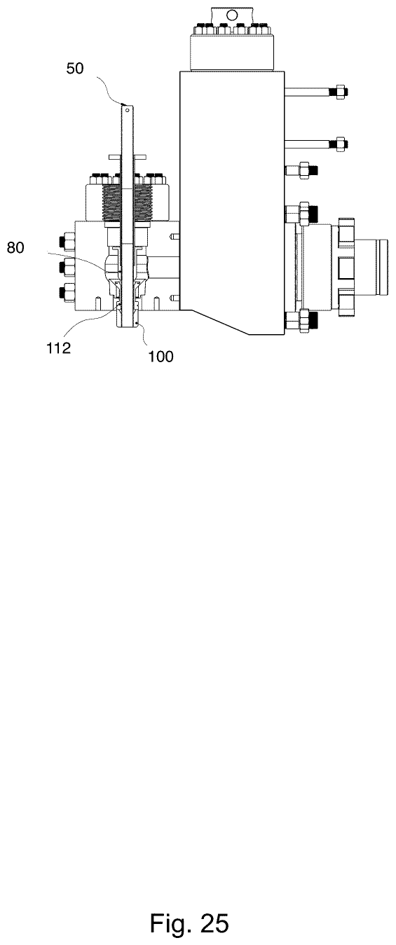

FIG. 26 is a cross sectional view of the fluid end of a reciprocating pump.

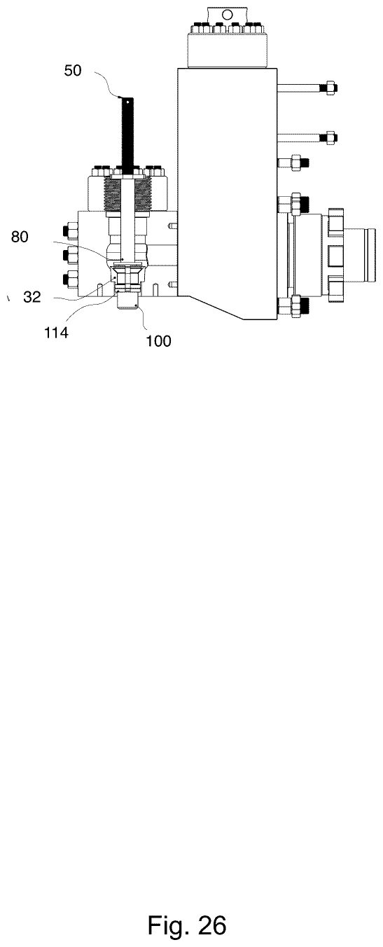

FIG. 27 is a cross sectional view of the fluid end of a reciprocating pump.

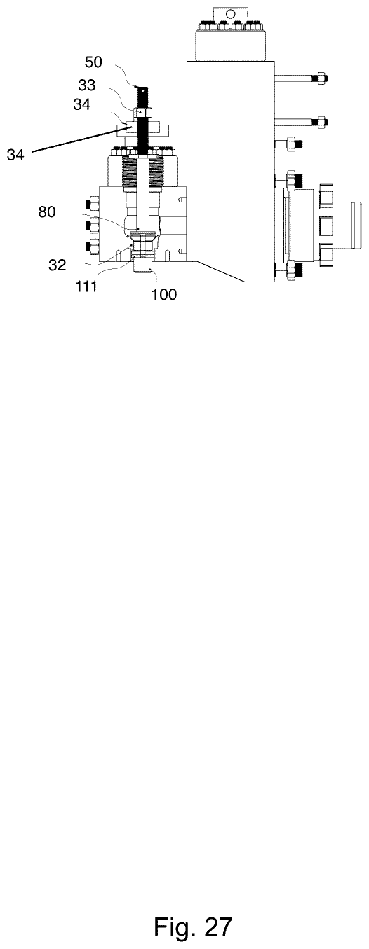

FIG. 28 is a top, perspective view of a seat puller assembly; the view showing the seat puller assembly having a stem; the view showing the seat puller assembly having an expander; the view showing the seat puller assembly having a jaw assembly; the view showing the seat puller assembly having a lower retaining nut.

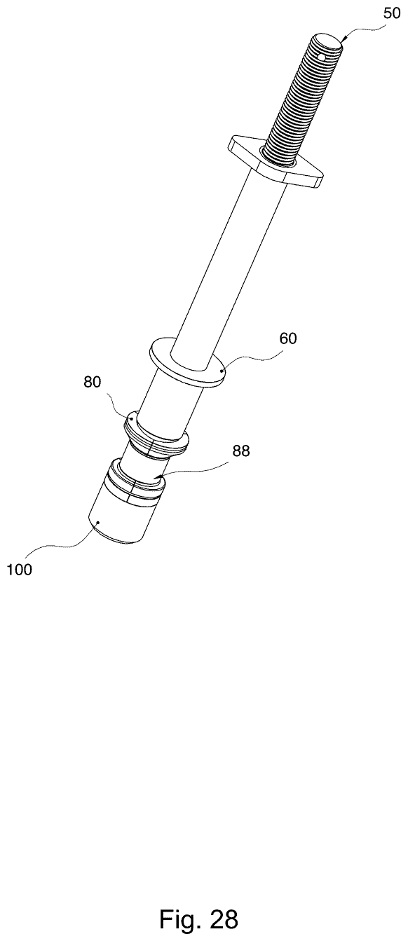

FIG. 29 is a front view of a seat puller assembly and expanding rotator tool; the view showing the expanding rotator tool disengaged with the seat puller assembly; the view showing the seat puller assembly having a stem; the view showing the seat puller assembly having an expander; the view showing the seat puller assembly having a jaw assembly; the view showing the seat puller assembly having a lower retaining nut.

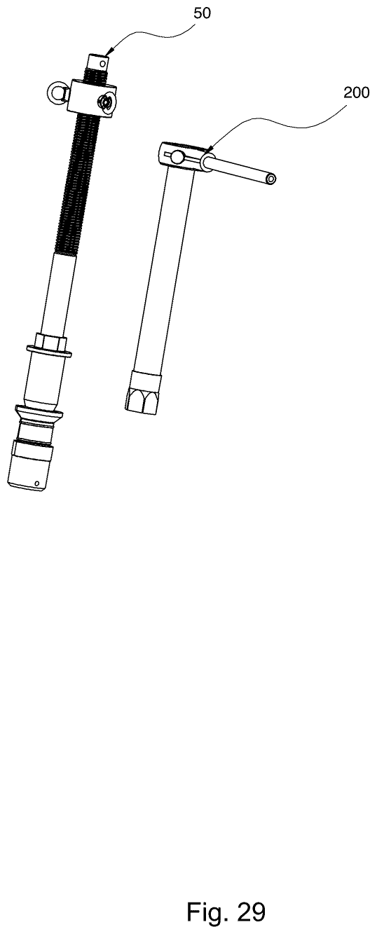

FIG. 30 is a cross sectional view of a seat puller assembly; the view showing the seat puller assembly having a stem; the view showing the seat puller assembly having an expander; the view showing the seat puller assembly having a jaw assembly; the view showing the seat puller assembly having a lower retaining nut.

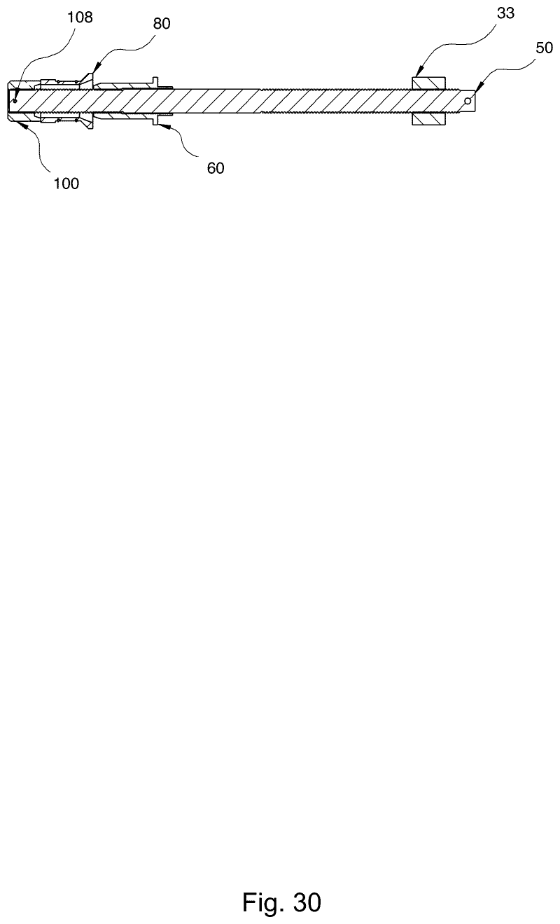

FIG. 31 is a side view of a stem; the view showing the stem extending a length from a first end to a second end; the view showing threading; the view showing a through hole; the view showing a second hole.

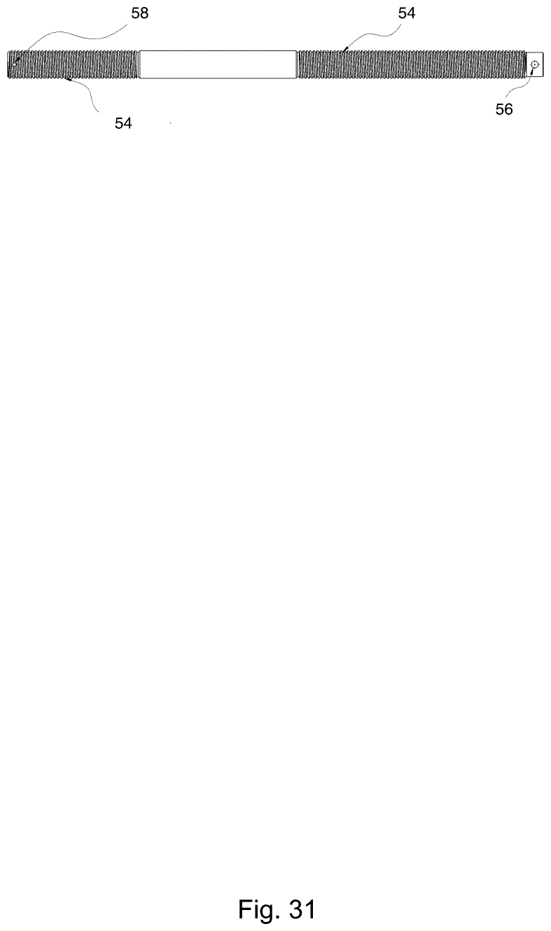

FIG. 32 is a cross sectional view of an expander; the view showing the expander extending a length from a first end to a second end; the view showing the expander having a handle; the view showing the expander having a flange; the view showing the expander having threading.

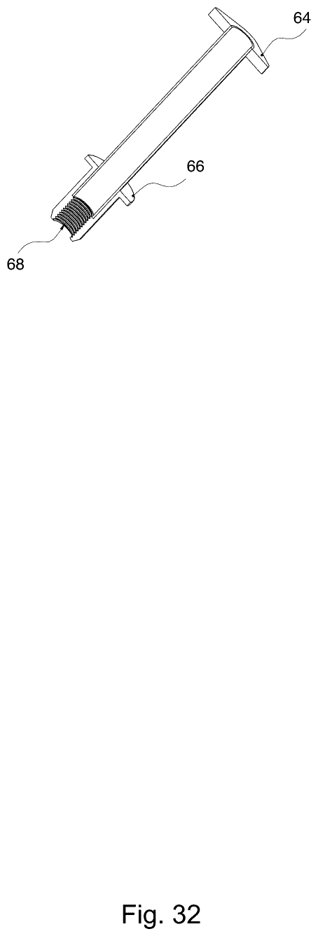

FIG. 33 is a cross sectional view of an expander; the view showing the expander extending a length from a first end to a second end; the view showing the expander having a handle; the view showing the expander having a flange; the view showing the expander having threading.

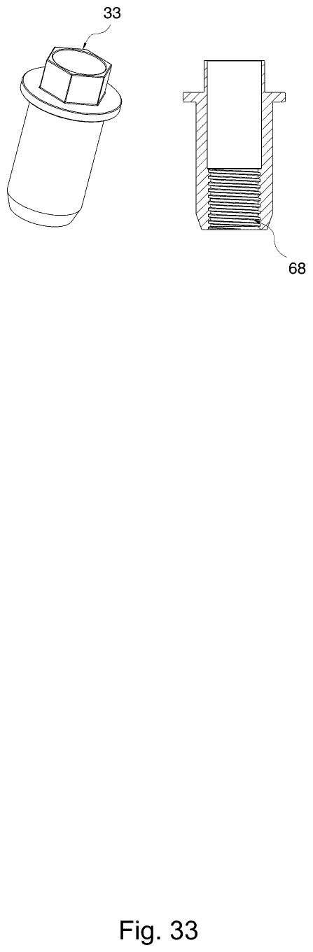

FIG. 34 is a front view of an expander rotating tool; the view showing the ratchet disengaged from the tube.

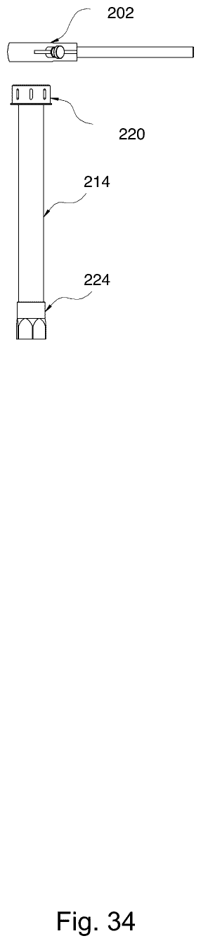

FIG. 35 is a top, perspective view of a jaw assembly; the view showing a jaw segment; the view showing a first o-ring; the view showing an elastomer band; the view showing a second o-ring.

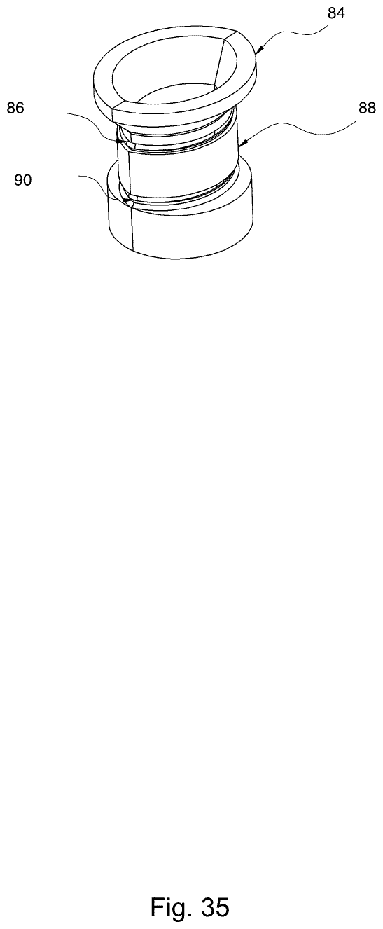

FIG. 36 is a top, perspective view of a lower retaining nut; the view showing a bevel; the view showing threading; the view showing a roll pin hole.

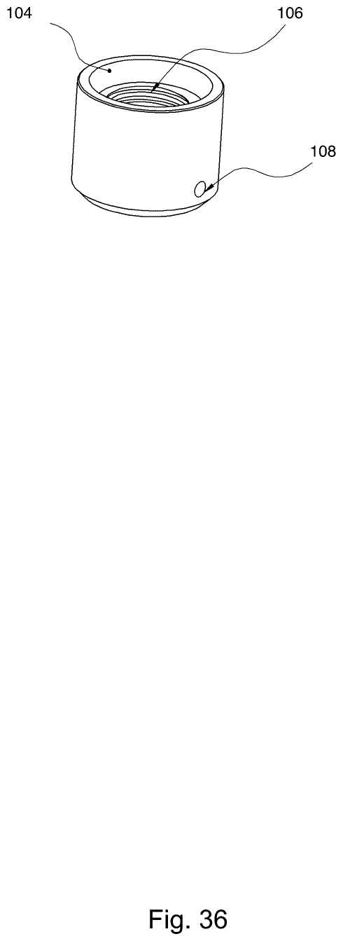

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

### System

With reference to the figures, a seat puller system, a reciprocating pump valve seat puller assembly, process, and method of use 10 are presented. a seat puller system, a reciprocating pump valve seat puller assembly, process, and method of use 10 (hereafter referred to as “seat puller system”, “seat puller”, “reciprocating pump valve seat puller”, “valve seat puller”, “seat puller”, or simply “system”) is formed of any suitable size, shape and design.

In the arrangement shown, as one example, system 10 is configured and designed to provide a seat puller system 10 which improves upon the state of the art. In the arrangement shown, as one example, system 10 is a uniquely designed and configured system which provides owners and service companies with a cost-effective solution that provides a more robust seat puller; which improves upon the life-span, as compared to existing seat pullers. Furthermore, the present disclosure and design reduces potential safety risks.

In the arrangement shown, as one example, the seat puller system 10 is designed and configured of a high strength steel. However, various alloys, carbon fiber, steel alloys, metal alloys, and the like.

In the arrangement shown, as one example, system 10 is designed and configured so that the installation can be completed with the through hole, which is machined on one end, and designed to provide for installing a pin and/or other device which prevents the stem from turning when rotating the expander.

In the arrangement shown, as one example, system 10 is configured with a number of advantages over existing valve seat pullers in the art. Said another way, existing seat puller designs have jaws that are placed in tension which results in high stresses which fail. The system 10 presented herein includes a lower retainer nut design which is uniquely designed to support the bottom shoulder of the jaw. This design places the bottom shoulder in compression, which contrasts in opposite trains of thoughts to those designs in the state of the art.

Furthermore, and in the arrangement shown as one example, the expander component of system 10 prevents the jaw from deflecting towards the stem, which is another unique feature and design of the present system. Said another way, this prevents a common issue affecting the present state of the art.

Furthermore, system 10 is designed and configured with far fewer components than are required in existing seat pullers. In this way, the manufacturing costs, maintenance costs, replacement costs, and the like are improved and more effective.

In the arrangement shown, as one example, the main structure of system 10 may include a well 12 and a user 14, and a reciprocating pump 20, the reciprocating pump 20 having a power end 21 and a fluid end 22, a valve cover 30, a seat puller or stem assembly 40, and the like. Furthermore, and in the arrangement shown, as one example, system 10 includes a stem 50, an expander 60, a jaw assembly 80, and a lower retaining nut 70, among other components, features, and functionality.

### User (or Plurality Thereof)

In the arrangement shown, as one example, system 10 includes a user. User may be any user interacting with or utilizing the system 10. This may include viewing, assembling, installing, disassembling, performing maintenance on, controlling, analyzing, manipulating, and/or interacting with system 10. Users are not limited to a single user but may be a plurality of users and/or may also be referred to as a crew or maintenance crew/staff.

### Well

In the arrangement shown, as one example, system 10 may also include a well 14 (also referred to as “Well Bore”, “Oil Well”, “Gas Well”, or simply “Well”). Well may also be considered a drilling rig or similar overall structure. The applications, as will become apparent herein, may be part of a land-based right, a mobile drilling rig, or similar. Furthermore, the present disclosure is applicable or readily adaptable to any type of drilling rig with a pump and/or other supporting elements. Additional applications may include, but are not limited to, jack-up rigs, semisubmersibles, drills, drill ships, coil tubing rigs, well service rigs adapted for drilling and/or re-entry operations, and casing drilling rigs, among others within the scope of the present disclosure.

In one example, a drilling rig and/or well may include a mast, a rig floor, a crown block, a traveling block, a crown block being located at or near the top of the mast, a traveling block, the traveling block hanging from m the crown block by a drilling line, the drilling line extending from a lifting gear to drawworks for reeling in and/or out to cause the traveling block to be lowered and/or raised, an anchor, and the like as are commonly found among traditional rigs/wells. Finally, the rig and/or well may include a mud pump system.

### Mud Pump

In the arrangement shown, as one example, system 10 includes a mud pump 16 (also referred to as “reciprocating pump”, “multiplex pump”, or simply “pump”). Pump 16 is formed of any suitable size, shape, and design, and is configured to provide high pressure fluid 18 to a well at a well bore.

In the arrangement shown, as one example, the reciprocating pump 16 includes a fluid end 22—having a high pressure area 23 and a low pressure area 24—a plurality of blocks 25, a plurality of openings 26, and a bore 27, and a power end 28, among other components and functionality.

In the arrangement shown, as one example, multiplex pump 16 is configured to receive the high pressure fluid (also known as “drilling fluid”, or “mud”), oftentimes from a tank, and deliver the high pressure fluid to the string through a hose or other conduit. In the present disclosure, the exemplary systems disclosed, by example and for ease of explanation are mainly the fluid end and in particular the valve cover assembly 10 of the fluid end 22 of the mud pump 16. The fluid end may also include an intake, a discharge, and other features. The high pressure of the fluid end requires a valve cover assembly.

### Stem

In the arrangement shown, as one example, system 10 includes a stem 40 (also referred to as “stem assembly”, “stem system”, or simply “stem”). Stem 40 is formed of any suitable size, shape, and design, and is configured to provide for installation. More specifically, and without limitation, the stem extends a length from a first end 52 to a second end 53 with threading 54. The stem 50 is configured with a through hole, machined and designed, to accept a pin and/or other device to prevent the stem 50 from turning and/or rotating when rotating the expander (to be further described herein).

In the arrangement shown, as one example, the stem is configured of high strength steel. However, other materials are hereby contemplated for use such as carbon fiber, steel alloys, metal alloys, and the like.

Said another way, and in the arrangement shown, as one example, the stem is configured with threaded high strength steel and is formed generally as a rod. The rod or stem in one arrangement is fully threaded. In another arrangement, the rod or stem is partially threaded. In another arrangement, the rod or stem is partially threaded at each end. Furthermore, and in the arrangement shown, the stem includes a first hole 56 or through hole which is machined into one end which is configured to provide for installing a pin and/or other device which prevents the stem from turning when rotating the expander. Furthermore, a second hole 58 is machined and/or included on the opposite end of the first hole as an anti-rotation device for the lower nut.

### Expander

In the arrangement shown, as one example, system 10 includes an expander 60 Expander 60 is formed of any suitable size, shape, and design, and is configured to expand the jaws, thereby locking the jaws around the valve seat during removal. Furthermore, the expander 60 is configured so that the lower end of the expander is tapered to engage the machined bevel located on the upper end of the jaw assembly.

Furthermore, and in the arrangement shown, the inside diameter of the expander 60 is threaded for installation on the stem. In this way, rotating the expander 60 clockwise causes the expander 60 to travel downward. Furthermore, in this way, rotating the expander 60 counterclockwise causes the expander 60 to travel upward. Furthermore, the flange (of the expander 60) is also configured to limit travel upward and/or downward through the jaw assembly.

In the arrangement shown, as one example, the expander 60 extends a length from a first end 62 to a second end 63. In the arrangement shown, as one example, expander 60 also includes a handle 64, a flange 66, and a plurality of threads 68, among other components, features, and functionality.

Said another way, and in the arrangement shown, as one example, the expander is configured to expand the jaws and/or lock them around the valve seat during removal. The lower end of the expander is tapered to engage the bevel located on the upper end of the jaw assembly. The inside diameter of the expander is threaded for installation on the stem. Rotating the expander clockwise causes the expander to travel down the stem while rotating the expander counterclockwise causes the expander to travel upward. The flange feature 66 limits the travel downward or upward of the expander along the length of the jaw assembly.

### Jaw Assembly

In the arrangement shown, as one example, system 10 includes a jaw assembly 80 (also referred to as “jaw expander”, “jaw expander assembly”, or simply “jaw”). Jaw assembly 80 is formed of any suitable size, shape, and design, and is configured with multiple jaw segments 84 or “jaw halves” or “jaw half”.

In the arrangement shown, as one example, jaw expander assembly 80 includes two jaw segments 84, each of which forming 180 degrees. Said another way, jaw expander assembly 80 includes two jaw segments each forming a segment of 180 degrees.

In another arrangement, as one example, jaw expander assembly 80 includes three jaw segments 84, each of which forming 120 degrees. Said another way, jaw expander assembly 80 includes three jaw segments each forming a segment of 120 degrees.

The jaw assembly 80 also includes a plurality of o-rings and/or garter springs installed within the grooves of the jaw assembly, around the top and the bottom flanges of the jaw. The plurality of o-rings and/or springs combined with the elastomeric band installed around the center of the jaws keep the assembly in a retracted state 112 when not energized by the expander.

In the arrangement shown, as one example, the jaw assembly 80 extends a length from a first end 82 to a second end 83 having a plurality of jaw segments 84, and a plurality of o-rings including a first o-ring 86 and a second o-ring 90, and an elastomer band 88, among other features, components, and functionality. The jaw expander assembly also includes an expanded jaw 114 or engaged jaw and a retracted jaw 112 or disengaged jaw.

In the arrangement shown, as one example, system 10 includes a plurality of jaw segments 84. Jaw segments 84 may also be referred to as jaw halves or jaw halfs. In the arrangement shown, as one example, jaw segments each form an arc of approximately 120 degrees to 180 degrees. The multiple jaw segments are formed to provide a gripping feature when activated. Activating the jaw half causes grip and/or tightening.

In the arrangement shown, as one example, the o-rings or garter springs and/or elastomeric bands and/or a combination of these items are installed in grooves around the body of the jaw assembly. The o-rings and/or garter springs and/or a combination of these items keep the jaws in a retracted position when not energized by the expander.

### Lower Retaining Nut

In the arrangement shown, as one example, system 10 includes a retaining nut 100 (also referred to as “retaining nut”, “retainer”, or simply “nut”). Lower retaining nut 100 is formed of any suitable size, shape, and design, and is configured to prevent downward movement of the jaw assembly during operation. In the arrangement shown, as one example, the lower retaining nut 100 is threaded along the inside diameter. In this way, the thread matches the bevel on the upper end so as to engage the lower end of the expander.

In the arrangement shown, as one example, the lower retaining nut 100 extends a length from a first end 102 to a second end 103 and includes a bevel 104 and a plurality of threads 106, and a roll pin hole 108, among other components, features, and functionality.

Said another way, and in the arrangement shown, as one example, the lower retaining nut prevents downward movement of the jaw assembly during operation. The inside diameter of the lower retaining nut is threaded with internal threads to match the threading of the stem. The lower retaining nut also includes a bevel on the upper end and/or first end of the lower retaining nut. The bevel is configured to engage the lower end or second end of the expander. Furthermore, the lower retaining nut includes a hole which is drilled through the bottom or second end of the nut, or located near the second end and/or bottom of the lower retaining nut. The hole or roll pin hole is sized and shaped to receive a roll pin. A roll pin is to be installed after the nut has been threaded on the stem. The roll pin is configured to prevent rotation between the lower nut and the stem.

### Operation

Furthermore, and in the arrangement shown, as one example, system 10 is designed for operation of the valve seat puller including installation. Installation of system 10 beings by installing in a fluid end of a reciprocating pump which is new and/or has had the previous valve and/or spring removed. With the expander in the raised position and/or not engaged with the jaw assembly, the seat puller 10 will drop through the valve seat, stopping when the upper flange of the jaw contacts the upper end of the valve seat.

Once the upper end of the valve seat is engaged by the upper flange of the jaw, the handle of the expander is then rotated, causing the expander to travel down the stem. Continued rotation of the expander causes it to thread down past the jaw assembly, expanding the jaw segments. The lower shoulder of the jaw segments then become locked under the bottom face of the valve seat.

With the valve seat puller in position and locked onto the valve seat, the hydraulic jack and upper hex nut are installed over the stem. Furthermore, pressurizing the jack causes the jack to extend, which in turn applies an upward force on the stem. In this way, the upward force is transmitted through the stem to the lower retaining nut. Furthermore, continued upward movement of the puller assembly then causes the lower retaining nut to force the jaws upward and against the bottom of the valve seat until such force is generated to dislodge the valve seat from the fluid end bore.

Once the valve seat has been dislodged from the bore, the puller assembly with the seat attached is removed from the fluid end of the reciprocating pump. The expander is then rotated counterclockwise to raise it above the jaw assembly, the o-rings and elastomeric band installed around the jaw segments then causes the jaw assembly to retract. With the jaw retracted, the valve seat can be removed from the puller assembly 10.

### Alternative Embodiment

In an alternative embodiment, also shown by example, system 1000 is formed of a stem assembly and expander rotating tool. In this arrangement, the expander rotating tool is configured to work in concert with the stem assembly. Said another way, system 1000 is formed of two primary assemblies, a stem assembly, and an expander rotating tool.

In this arrangement, as one example, the expander is configured with an alternate expander which utilizes a separate tool for rotating the expander. In this embodiment, a socket attached to a length of steel tubing is included. The upper end or first end of the tubing includes a ratchet head. The ratchet is sized and adapted such that the ratchet head is installed during operation to rotate the tool and expander. The ratchet is reversible and reduces effort by the operator when rotating the expander.

Furthermore, the design is configured to accommodate different fluid end designs, the length of the steel tube can be extended (to a longer length) or shortened (to a shorter length) to fit a specific fluid end, as needed.

Expander Rotating Tool: In the embodiment, the expander rotating tool 200 includes a ratchet 202 extending a length extending from a first end 206 to a second end 208 having a handle 209, a ratchet feature 210, a ratchet adjustment feature 212. Furthermore, the tool may include a tube 214 extending a length from a first end 218 having a ratchet head 220 to a second end 222 having a socket 224—the tool having a reversible adjustment 226 and an extension feature 228, among other features and components.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A seat puller system, comprising:
a stem;
the stem extending a length from a first end to a second end;
the stem having a threading;
the stem having a through hole;
an expander;
the expander extending a length from a first end to a second end;
the expander having a flange;
the expander having threads;
a jaw assembly;
the jaw assembly extending a length from a first end to a second end;
the jaw assembly having a jaw segment;
the jaw assembly having an elastomer band;
a lower retaining nut;
the lower retaining nut extending a length from a first end to a second end;
the lower retaining nut having threads;
the expander having a disengaged position; wherein the disengaged position is when the expander is disengaged from the jaw assembly;
the expander having an engaged position; wherein the engaged position is when the expander is engaged with the jaw assembly;
wherein the expander is rotated and forced to travel down the stem;
wherein continued rotation of the expander as it travels down the stem causes the expansion of the jaw segments due to downward force on the jaw expander.

2. The system of claim 1, further comprising:
a reciprocating pump;
the reciprocating pump having a power end;
the reciprocating pump having a fluid end;
a valve cover assembly;
the valve cover assembly having a valve;
the valve cover assembly having a valve seat;
the valve cover assembly having a hex nut;
the valve cover assembly having a hydraulic jack.

3. The system of claim 1, further comprising:
the stem having a second hole.

4. The system of claim 1, further comprising:
the expander having a handle.

5. The system of claim 1, further comprising:
the expander having a bevel feature.

6. The system of claim 1, further comprising:
the jaw assembly having a first o-ring;
the jaw assembly having a second o-ring.

7. The system of claim 1, further comprising:
the jaw assembly having an o-ring.

8. The system of claim 1, further comprising:
the lower retaining nut having a bevel.

9. The system of claim 1, further comprising:
the lower retaining nut having a roll pin hole.

10. The system of claim 1, further comprising:
wherein the lower shoulder of the jaw segments lock into place due to the downward force on the jaw expander.

11. The system of claim 1, further comprising:
a valve seat;
a threaded expander to engage or disengage the jaws from the valve seat.

12. A valve seat puller with a ratcheting expander tool, comprising:
a stem;
the stem extending a length from a first end to a second end;
the stem having a threading;
an expander;
the expander extending a length from a first end to a second end;
the expander having a flange;
the expander having threads;
the expander having a bevel feature;
the expander having a disengaged position; wherein the disengaged position is when the expander is disengaged from the jaw assembly;
the expander having an engaged position; wherein the engaged position is when the expander is engaged with the jaw assembly;
a jaw assembly;
the jaw assembly extending a length from a first end to a second end;
the jaw assembly having a jaw segment;
the jaw assembly having a first o-ring;
the jaw assembly having an elastomer band;
a lower retaining nut;
the lower retaining nut extending a length from a first end to a second end;
the lower retaining nut having a bevel;
the lower retaining nut having threads;
an expander rotating tool;
the expander rotating tool having a ratchet;
the ratchet extending a length from a first end to a second end;
the ratchet having a handle;
the ratchet having a ratchet feature;
the expander rotating tool having a tube;
the tube extending a length from a first end to a second end;
the tube having a ratchet head;
the tube having a socket;
wherein the expander is rotated and forced to travel down the stem; wherein the expander is forced to travel down the stem by the rotation of the expander rotating tool;
wherein continued rotation of the expander as it travels down the stem causes the expansion of the jaw segments due to downward force on the jaw expander;
wherein the lower shoulder of the jaw segments lock into place due to the downward force on the jaw expander.

13. The system of claim 12, further comprising:
a reciprocating pump;
the reciprocating pump having a power end;
the reciprocating pump having a fluid end;
a valve cover assembly;
the valve cover assembly having a valve;
the valve cover assembly having a valve seat;
the valve cover assembly having a hex nut;
the valve cover assembly having a hydraulic jack.

14. The system of claim 12, further comprising:
the stem having a through hole;
the stem having a second hole.

15. The system of claim 12, further comprising:
the expander having a handle.

16. The system of claim 12, further comprising:
the lower retaining nut having a roll pin hole.

17. The system of claim 12, further comprising:
the jaw assembly having a second o-ring.

18. The system of claim 12, further comprising:
the tube having a reversible adjustment feature;
the tube having an extension feature.

19. The system of claim 12, further comprising:
the ratchet having a ratchet adjustment feature.

20. A method of using a reciprocating pump valve seat puller assembly, comprising the steps:
providing a seat puller assembly; wherein the seat puller assembly includes a stem, an expander, a jaw assembly, and a lower retaining nut;
the stem extending a length from a first end to a second end;
the stem having a threading;
the stem having a through hole;
the stem having a second hole;
the expander extending a length from a first end to a second end;
the expander having a handle;
the expander having a flange;
the expander having threads;
the expander having a bevel feature;
the expander having a disengaged position; wherein the disengaged position is when the expander is disengaged from the jaw assembly;
the expander having an engaged position; wherein the engaged position is when the expander is engaged with the jaw assembly;
the jaw assembly extending a length from a first end to a second end;
the jaw assembly having a jaw segment;
the jaw assembly having a first o-ring;
the jaw assembly having a second o-ring;
the jaw assembly having an elastomer band;
the lower retaining nut extending a length from a first end to a second end;
the lower retaining nut having a bevel;
the lower retaining nut having threads;
the lower retaining nut having a roll pin hole;
providing an expander rotating tool;
the expander rotating tool having a ratchet;
the ratchet extending a length from a first end to a second end;
the ratchet having a handle;
the ratchet having a ratchet feature;
the ratchet having a ratchet adjustment feature;
the expander rotating tool having a tube;
the tube extending a length from a first end to a second end;
the tube having a ratchet head;
the tube having a socket;
the tube having a reversible adjustment feature;
the tube having an extension feature;
placing the expander tool on the stem of the seat puller assembly;
rotating the expander tool;
wherein the expander is rotated and forced to travel down the stem; wherein the expander is forced to travel down the stem by the rotation of the expander rotating tool;
wherein continued rotation of the expander as it travels down the stem causes the expansion of the jaw segments due to downward force on the jaw expander;
wherein the lower shoulder of the jaw segments lock into place due to the downward force on the jaw expander;
engaging the seat puller for operation.
